(19) United States
(12) Patent Application Publication
(10) Pub. No.: US 2009/0184699 A1
(43) Pub. Date: Jul. 23, 2009

(54) POWER SUPPLY APPARATUS AND POWER SUPPLY METHOD

(75) Inventors: Masahiro Natsume, Kasugai (JP); Katsuyuki Yasukouchi, Kasugai (JP)

Correspondence Address: Fujitsu Patent Center;C/O CPA Global, P.O. Box 52050, Minneapolis, MN, 55402, US

(73) Assignee: JUJITSU MICROELECTRONICS LIMITED, Tokyo (JP)

(21) Appl. No.: 12/354,413

(22) Filed: Jan. 15, 2009

(30) Foreign Application Priority Data
Jan. 16, 2008 (JP) JP2008-007414

(51) Int. Cl. G05F 1/10

(52) U.S. Cl. 323/282

(57) ABSTRACT

A power supply apparatus is described that includes a first switch, a second switch, a first comparator, a signal generator and a controller. The first switch is provided between an inductor and a terminal having a reference voltage. The second switch is provided between the inductor and an output terminal. The first comparator compares an input voltage and a first comparison voltage. The signal generator outputs a frequency signal based on an output of the first comparator. The first controller controls current flowing into the inductor by controlling the first switch and the second switch based on the output of the signal generator.

### CROSS-REFERENCE TO RELATED APPLICATION

This application is based upon and claims the benefit of priority of the prior Japanese Patent Application No. 2008-007414, filed on Jan. 16, 2008, the entire contents of which are incorporated herein by reference.

### BACKGROUND

1. Field

The present application relates to a power supply apparatus and a power supply method.

2. Description of the Related Art

FIG. 1 illustrates a related power apparatus 220. The power apparatus 220 is a so-called double conversion type power apparatus. A battery 201 is coupled to the power apparatus 220. The battery may be a lithium ion battery of one cell. An input voltage Vin, which is supplied from the battery, may fluctuate within the range of about 2.8 V to about 4.2 V. The input voltage Vin is stepped up by a step-up DC-DC converter 204, and an output voltage Vo201 which is regulated to a set output voltage value of about 4.8 V may be obtained. The output voltage Vo201 is stepped down by a DC-DC converter 209, and an output voltage Vo202 which is set to about 3.3 V may be obtained. The output voltage Vo201 is stepped down by a Low/Linear DropOut (LDO) 210, and an output voltage Vo203 which is set to about 3.3 V may be obtained.

As shown in FIG. 1, in the power apparatus 220, the voltage equal to or higher than the set output voltages Vo202 and Vo203 is supplied from the DC-DC converter 204 to the DC-DC converter 209 and the LDO 210. The output voltages Vo202 and Vo203 regulated to the output voltage value which is set to about 3.3 V are outputted from the DC-DC converter 209 and the LDO 210.

As further shown in FIG. 1, the power apparatus 220 includes a circuit which supplies a voltage equal to or higher than the set output voltage Vo202 to the DC-DC converter 209 without performing the step-up operation at the DC-DC converter 204 when the input voltage Vin is higher than the set output voltages Vo202 and Vo203. Further, the power apparatus 220 includes a circuit which supplies a voltage equal to or higher than the set output voltage Vo203 to the LDO 210 without performing the step-up operation at the DC-DC converter 204. In both of the cases mentioned above, with the redundant circuit operation being performed by operating the DC-DC converter 204 at a constant frequency, power loss occurs.

### SUMMARY

At least one embodiment of the present invention provides a power supply apparatus. The power supply apparatus includes a first switch provided between an inductor and a terminal having a reference voltage, a second switch which provided between the inductor and an output terminal, a first comparator comparing a first input voltage and a second input voltage, a signal generator to output a frequency signal based on an output of the first comparator, and a first controller to control current flowing into the inductor by controlling the first switch and the second switch based on the output of the signal generator.

It is to be understood that both the foregoing summary description and the following detailed description are explanatory as to some embodiments of the present invention, and not restrictive of the present invention as claimed.

### BRIEF DESCRIPTION OF THE DRAWINGS

In the figures, dimensions and/or proportions may be exaggerated for clarity of illustration. It will also be understood that when an element is referred to as being “connected to” another element, it may be directly connected or indirectly connected, i.e., intervening elements may also be present. Further, it will be understood that when an element is referred to as being “between” two elements, it may be the only element between the two elements, or one or more intervening elements may also be present. Like reference numerals refer to like elements throughout.

FIG. 1 depicts a related power supply apparatus;

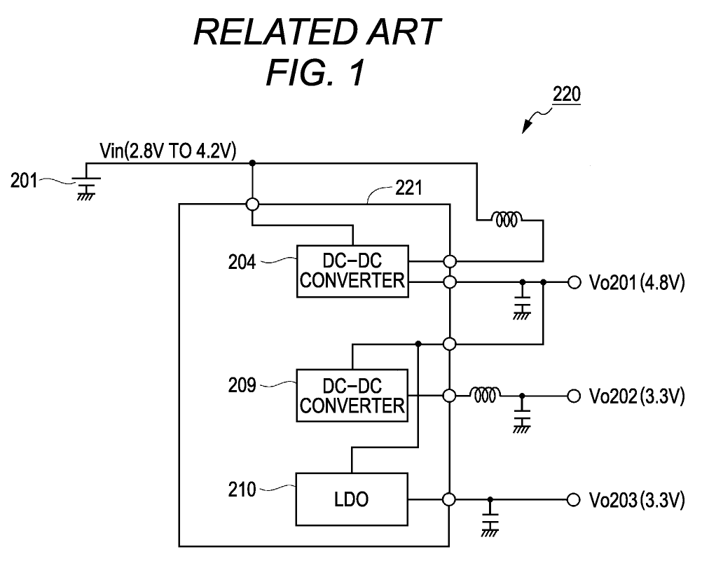

FIG. 2 depicts a power apparatus according to an example of an embodiment of the present invention;

FIG. 3 depicts a Voltage-Controlled Oscillator (VCO) 1 of FIG. 2 according to an example of an embodiment of the present invention;

FIG. 4 depicts the relation between input and output voltages according to an example of an embodiment of the present invention depicted in FIG. 2;

FIG. 5 depicts operating waveforms according to an example of an embodiment of the present invention depicted in FIG. 2;

FIG. 6 depicts a correlation diagram between the input voltage Vin and the output voltage Vo1 according to an example of an embodiment of the present invention depicted in FIG. 2;

FIG. 7 depicts a power apparatus according to an example of an embodiment of the present invention;

FIG. 8 depicts the relation between input and output voltages according to an example of an embodiment of the present invention depicted in FIG. 7;

FIG. 9 depicts operating waveforms of an example of an embodiment of the present invention depicted in FIG. 7; and

FIG. 10 depicts electronic equipment according to an example of an embodiment of the present invention.

### DETAILED DESCRIPTION OF THE EMBODIMENTS

Among other things, the following description discusses ranges. All ranges including the term “about” should also be understood as describing and including the corresponding ranges without the term “about.” For example, the range from about 5% to about 10% includes the range from 5% to 10%.

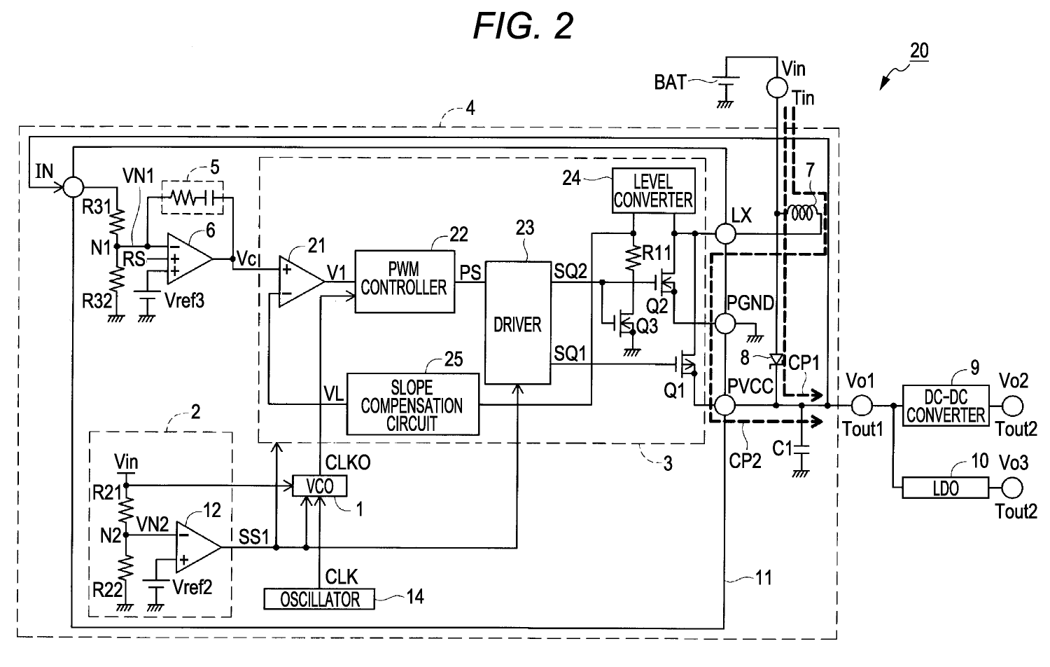

FIG. 2 depicts a double conversion type power apparatus. The power apparatus 20 includes a battery BAT, a step-up DC-DC converter 4, a step-down DC-DC converter 9 and a Low/Linear DropOut regulator (LDO) 10. The battery BAT is a power source of the power apparatus 20. An input terminal Tin of the DC-DC converter 4 is coupled to an output terminal of the battery BAT in order to supply an input voltage Vin. The battery may be a lithium ion battery of one cell, for example. The value of the input voltage Vin which is supplied from the battery BAT is within the range of about 2.8 V to about 4.2 V, for example.

As shown in FIG. 2, an output voltage Vo1 is supplied by coupling an output terminal Tout1 of the DC-DC converter 4 to the input terminals of the DC-DC converter 9 and the LDO 10. The output voltage Vo1 is a power source voltage of the DC-DC converter 9 and the LDO 10. The output voltage Vo1 may be set to a value of about 3.65 V or higher, which is a set output voltage value Vset, for example. The output voltage Vo1 is stepped down by the DC-DC converter 9, and an output voltage Vo2, which is about 3.3 V for example, is outputted from an output terminal Tout2. The output voltage Vo1 is stepped down at LDO 10, and an output voltage Vo3, which is about 3.3 V for example, is outputted from an output terminal Tout3. In this case, the power apparatus 20 outputs the output voltages Vo2 and Vo3. The output voltages Vo2 and Vo3 are regulated to the output voltage value which is set to about 3.3 V, for example.

An example method of determining the set output voltage value Vset is explained below. For example, the output voltage Vo1 may need to be higher than the output voltage Vo2 by a specified voltage value so that the DC-DC converter 9 may stably perform the step-down operation. Further, the output voltage Vo1 may need to be higher than the output voltage Vo3 by a specified voltage value so that the LDO 10 stably performs the step-down operation. The specified voltage value for the stable operation of the DC-DC converter 9 and the LDO 10 is about 0.3 V, for example. As indicated above, the set output voltage value Vset may be set to about 3.65 V which is about 0.3 V or more larger than the set value (about 3.3 V, for example) of the output voltages Vo2 and Vo3. Here, the value of the output voltage Vo1 may fluctuate as long as the value is larger than about 3.65 V.

As further shown in FIG. 2, the DC-DC converter 4 includes a coil 7, a Schottky-Barrer Diode (SBD) 8, an output capacitor C1, a control circuit 11, the input terminal Tin and the output terminal Tout1. One end of the coil 7 is coupled to a terminal LX of the control circuit 11. The other end of the coil 7 is coupled to the input terminal Tin and an anode terminal of the SBD 8. A cathode terminal of the SBD 8, the output capacitor C1, and a terminal PVCC and a terminal IN of the control circuit 11 are all coupled to the output terminal Tout1. A terminal PGND of the control circuit 11 is grounded.

As further shown in FIG. 2, the control circuit 11 has a Voltage-Controlled Oscillator (VCO) 1, a comparison circuit 2, a switching controller 3, resistance elements R31 and R32, an error amplifier 6, a phase compensation circuit 5 and an oscillator 14.

As further shown in FIG. 2, the comparison circuit 2 includes a comparator 12, resistance elements R21 and R22 and a reference voltage Vref2. The input voltage Vin is inputted to one end of the resistance element R21, and the other end of the resistance element R21 is coupled to one end of the resistance element R22 via a node N2. The other end of the resistance element R22 is grounded. The resistance elements R21 and R22 are voltage division resistances for dividing the input voltage Vin. In the case that the input voltage Vin is about 4.0 V, for example, the voltage division resistances are set so that a divided voltage VN2 becomes substantially equal to the reference voltage Vref2. The node N2 is coupled to an inverting input terminal of the comparator 12. Accordingly, the divided voltage VN2 is inputted to the inverting input terminal of the comparator 12. The reference voltage Vref2 is inputted to a non-inverting input terminal of the comparator 12. The comparator 12 outputs a signal SS1 based on a comparison of the divided voltage VN2 and the reference voltage Vref2. For example, the comparator 12 outputs a signal SS1 having a high level when the divided voltage VN2 is lower than the reference voltage Vref2 and outputs the signal SS1 having low level when the divided voltage VN2 is higher than the reference voltage Vref2. The signal SS1 is inputted to the VCO 1, the switching controller 3 and a driver 23.

As further shown in FIG. 2, the signal SS1 is inputted to the VCO 1. Further, a clock signal CLK is inputted to the VCO 1 from the oscillator 14. The clock signal CLK is a signal which may have a fixed frequency. For example, the clock signal CLK may have a fixed frequency of 1.25 MHz. A control clock signal CLKO is outputted from the VCO 1.

As further shown in FIG. 2, one end of the resistance element R31 is coupled to the terminal IN, and the other end of the resistance element R31 is coupled to one end of the resistance element R32 via a node N1. The other end of the resistance element R32 is grounded. The resistance elements R31 and R32 are voltage division resistances for dividing the output voltage Vo1. The error amplifier 6 is set to differentially amplify the divided voltage VN1 and a reference voltage Vref3. The error amplifier 6 is a voltage amplifier which has two non-inverting inputs and one inverting input. The node N1 is coupled to the inverting input of the error amplifier 6. The reference voltage Vref3 is inputted to one of the two non-inverting inputs of the error amplifier 6. A ramp control signal RS is inputted to the other non-inverting input of the error amplifier 6 from a ramp control circuit which is not shown in figures. The lower voltage of the two non-inverting inputs of the error amplifier 6 is prioritized and the operation of amplifying the difference between the lower voltage of the two non-inverting inputs and the voltage of the inverting input is performed. The phase compensation circuit 5 is coupled between an output terminal and the inverting input terminal of the error amplifier 6. An output voltage Vc which is outputted from the error amplifier 6 is inputted to the switching controller 3.

As further shown in FIG. 2, the switching controller 3 includes a comparator 21, a Pulse Width Modulation (PWM) controller 22, the driver 23, a level converter 24, a slope compensation circuit 25, transistors Q1 through Q3 and a sense resistance R11. The slope compensation circuit 25 is a circuit for reducing or preventing subharmonic oscillation. By coupling the output terminal of the error amplifier 6 to a non-inverting input of the comparator 21, the output voltage Vc is inputted to the comparator 21. By coupling an output terminal of the slope compensation circuit 25 to an inverting input terminal of the comparator 21, an output voltage VL is inputted to the comparator 21. An output voltage V1 is outputted from the comparator 21 to the PWM controller 22. With the input of the output voltage V1 and the control clock signal CLKO to the PWM controller 22, a PWM signal PS is outputted to the driver 23. With the input of the PWM signal PS and the signal SS1 to the driver 23, gate signals SQ1 and SQ2 are outputted from the driver 23 to the transistors Q1 through Q3.

As further shown in FIG. 2, a source terminal of the PMOS transistor Q1 is coupled to the terminal PVCC. A drain terminal of the PMOS transistor Q1 is coupled to the terminal LX. A drain terminal of the NMOS transistor Q2 is coupled to the terminal LX and the level converter 24. A source terminal of the NMOS transistor Q2 is coupled to a terminal PGND. A drain terminal of the NMOS transistor Q3 is coupled to the level converter 24 and the slope compensation circuit 25 via the sense resistance R11. A source terminal of the NMOS transistor Q3 is grounded.

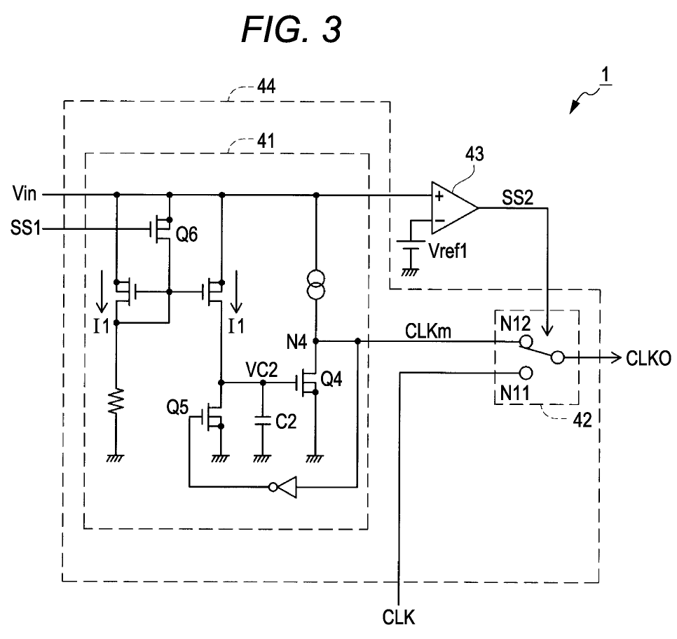

FIG. 3 depicts the VCO 1 of FIG. 2. The VCO 1 includes a comparator 43 and a clock signal generator 44. A reference voltage Vref1 of about 3.2 V, for example, is inputted to an inverting terminal of the comparator 43 and the input voltage Vin is inputted to a non-inverting input terminal of the comparator 43. A signal SS2 is outputted from the comparator 43. The clock signal generator 44 includes a voltage control oscillation unit 41 and a switch unit 42. The voltage control oscillation unit 41 is an example of a circuit which changes frequency of the clock signal based on the value of the input voltage Vin. For example, the voltage control oscillation unit 41 outputs a modulation clock signal CLKm based on the input voltage Vin. For example, the frequency of the modulation clock signal CLKm linearly decreases as the input voltage Vin increases. The modulation clock signal CLKm is inputted to a node N12 of the switch unit 42. The clock signal CLK is inputted to a node N11 of the switch unit 42. The signal SS2 outputted by the comparator 43 is inputted to the switch unit 42. The switch unit 42 alternatively selects either the clock signal CLK or the modulation clock signal CLKm based on the signal SS2 and outputs the selected signal as the control clock signal CLKO.

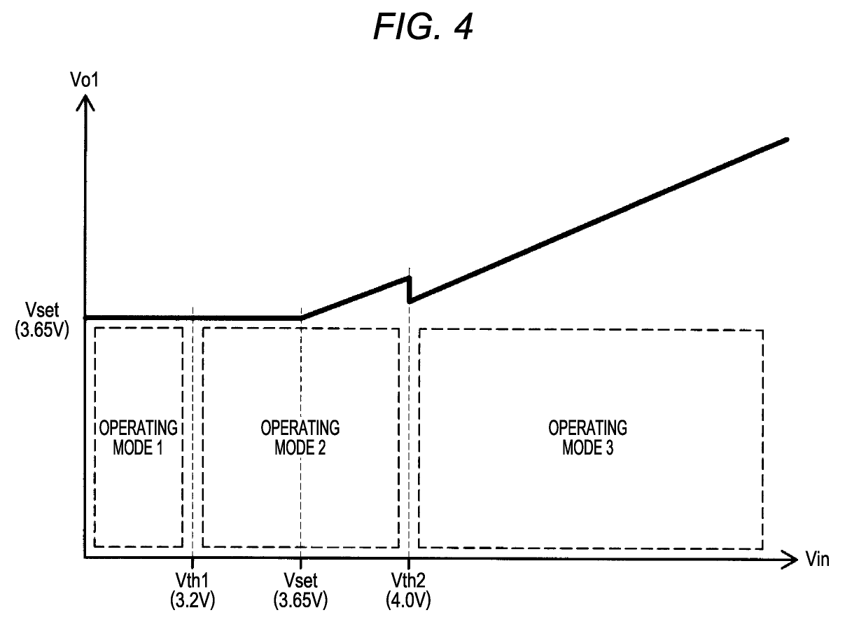

FIG. 4 depicts an example relation between input and output voltages of the power apparatus 20 depicted in FIG. 2. In the range where the input voltage Vin is lower than a threshold voltage Vth1, the DC-DC converter 4 of FIG. 2 performs the PWM operation at a fixed frequency. The operation in the range where the input voltage Vin is lower than the threshold voltage Vth1 is referred to as operating mode 1. In FIG. 4, the threshold voltage Vth1 is about 3.2 V, the operating frequency at the operating mode 1 is about 1.25 MHz, for example.

As shown in FIG. 4, in the range where the input voltage Vin is equal to or higher than the threshold voltage Vth1 and lower than a threshold voltage Vth2, the DC-DC converter 4 of FIG. 2 performs the PWM operation at the frequency which decreases based on the input voltage Vin. The operation in the range where the input voltage Vin is equal to or higher than the threshold voltage Vth1 and lower than a threshold voltage Vth2 is referred to as operating mode 2. In FIG. 4, the threshold voltage Vth2 is about 4.0 V, for example.

As further shown in FIG. 4, in the range where the input voltage Vin is equal to or higher than the threshold voltage Vth2, the DC-DC converter 4 is deactivated. The operation in the range where the input voltage Vin is equal to or higher than the threshold voltage Vth2 is referred to as operating mode 3.

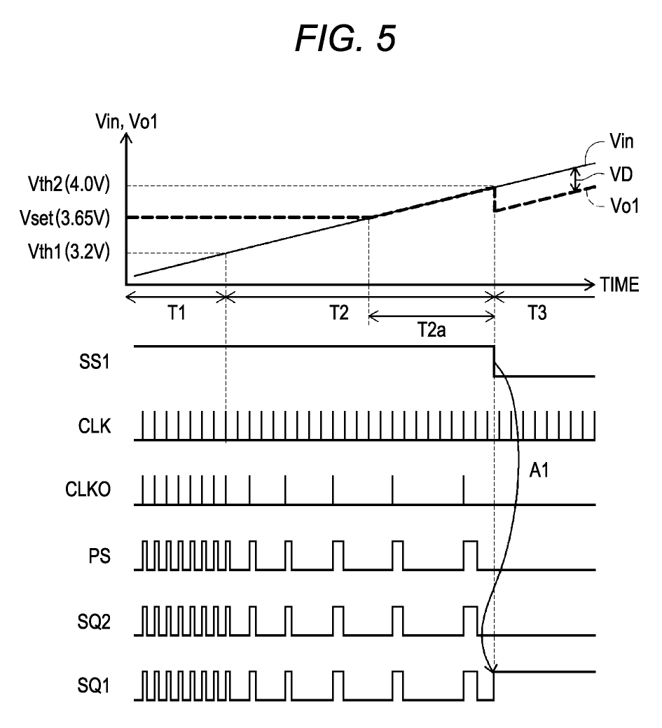

FIG. 5 depicts example operating waveforms of the power apparatus 20 depicted in FIG. 2. FIG. 5 includes a waveform of each signal in the case that the input voltage Vin changes from a value which is equal to or lower than the threshold voltage Vth1 toward a value which is equal to or higher than the threshold voltage Vth2 as time elapses.

The operation in the period T1, which is the range where the input voltage Vin is lower than the threshold voltage Vth1 (3.2 V, for example), is explained below. In the period T1, the DC-DC converter 4 of FIG. 2 is operating in the operating mode 1. During the period T1, the comparator 12 of the comparison circuit 2 of FIG. 2 compares the divided voltage VN2 and the reference voltage Vref2 and outputs the high level signal SS1. Based on the high level signal SS1, a transistor Q6 of the voltage control oscillation unit 41 of FIG. 3 of the VCO 1 of FIG. 2 is in a non-conductive state. Therefore, the voltage control oscillation unit 41 of FIG. 3 is in an operating state. Based on the high level signal SS1, the switching controller 3 of FIG. 2 is also in an operating state.

In the comparator 43 of the VCO 1 of FIG. 3, the input voltage Vin is detected as being lower than about 3.2 V, for example, and the low level signal SS2 is outputted. Based on the low level signal SS2, the switch unit 42 of FIG. 3 selects the node N11. Therefore, as shown in FIG. 5, the clock signal CLK of a fixed frequency of about 1.25 MHz, for example, is outputted as the control clock signal CLKO.

In the error amplifier 6 of FIG. 2, comparison between the divided voltage VN1 and the reference voltage Vref3 is performed and the output voltage Vc is outputted from the error amplifier 6 to the comparator 21. In the comparator 21 of FIG. 2, comparison between the output voltage Vc and the output voltage VL is performed and the output voltage V1 is obtained and provided to the PWM controller 22. In the PWM controller 22 of FIG. 2, the PWM signal PS is generated based on the control clock signal CLKO and the output voltage V1. The frequency of the PWM signal PS is determined by the control clock signal CLKO. The pulse width of the PWM signal PS is determined by the output voltage V1. The PWM signal PS is power-amplified at the driver 23 of FIG. 2 and outputted as the gate signals SQ1 and SQ2. Therefore, as further shown in FIG. 5, in the operation mode 1, the operation frequency of the transistors Q1 through Q3 is set to a fixed frequency of about 1.25 MHz, for example.

As further shown in FIG. 5, in the period when the gate signals SQ1 and SQ2 have a high level, the transistor Q1 of FIG. 2 is in a non-conductive state while the transistor Q2 of FIG. 2 and the transistor Q3 of FIG. 2 are in a conductive state. Accordingly, since current flows through the coil 7 via the transistor Q2, energy is accumulated at the coil 7. A coil current which is decreased by the level converter 24 at a specified ratio flows through the sense resistance R11 via the transistor Q3. The voltage outputted from the sense resistance R11 which corresponds to the coil current is inputted to the comparator 21 via the slope compensation circuit 25.

As further shown in FIG. 5, in the period when the gate signals SQ1 and SQ2 have a low level, the transistor Q1 of FIG. 2 is in a conductive state while the transistor Q2 of FIG. 2 and the transistor Q3 of FIG. 2 are in a non-conductive state. Accordingly, a current supply path CP2 from the coil 7 to the output terminal Tout1 via the terminal LX, the transistor Q1 and the terminal PVCC is formed. The energy accumulated at the coil 7 is discharged to the output terminal Tout1 through the current supply path CP2.

Next, the operation in the period T2 of FIG. 5, which is the range where the input voltage Vin is equal to or higher than the threshold voltage Vth1 (about 3.2 V, for example) and lower than the threshold voltage Vth2 (about 4.0 V, for example), is explained. In the period T2, the DC-DC converter 4 of FIG. 2 is operating in the operating mode 2. At this time, the comparator 12 of the comparison circuit 2 of FIG. 2 outputs the signal SS1 having a high level. Accordingly, the VCO 1 and the switching controller 3 are in an operating state.

In the comparator 43 of the VCO 1 of FIG. 3, the input voltage Vin is detected as being higher than about 3.2 V, for example, and the high level signal SS2 is outputted from the comparator 43 of FIG. 3 to the switch 42. Based on the high level signal SS2, the switch unit 42 selects the node N12. When the node N12 is selected, the modulation clock signal CLKm which is outputted from the voltage control oscillation unit 41 is outputted as the control clock signal CLKO.

The operation of the voltage control oscillation unit 41 of FIG. 3 is explained below. In the period in which a transistor Q4 is in a non-conductive state, the modulation clock signal CLKm has a high level. When the modulation clock signal CLKm has a high level, a transistor Q5 is in a non-conductive state. Therefore, the current I1 corresponding to the input voltage Vin flows into a capacitor C2 and the capacitor C2 is in a charging state. When the transistor Q4 is in a conductive state due to the increase of the output voltage VC2 of the capacitor C2, the modulation clock signal CLKm has a low level and the capacitor C2 is discharged with the conduction of the transistor Q5. When the transistor Q4 is in a non-conductive state again due to the decrease of the output voltage VC2 of the capacitor C2, the modulation clock signal CLKm has a high level and the capacitor C2 is in a charging state. In light of the abovementioned operation, the frequency of the modulation clock signal CLKm linearly changes based on the value of the input voltage Vin outputted from the voltage control oscillation unit 41.

In the explanation below, it is assumed that the frequency of the modulation clock signal CLKm is about 980 kHz when the input voltage Vin is about 3.2 V, for example, and about 420 kHz when the input voltage Vin is 4.0 V, for example. Accordingly, with the range of the input voltage Vin being about 3.2 V to about 4.0 V, the frequency of the modulation clock signal CLKm linearly changes within the range of about 980 kHz to about 420 kHz based on the input voltage Vin. In this case, the operating frequency of the transistors Q1 through Q3 is set within the range of about 980 kHz to about 420 kHz in the operating mode 2. In the operating mode 2, the energy accumulated at the coil 7 is discharged to the output terminal Tout1 through the current supply path CP2, as in the case described above with respect to operating mode 1.

In the operating mode 2, in the period T2a of FIG. 5, which is the range where the input voltage Vin is higher than the set output voltage value Vset (about 3.65V, for example) and lower than the threshold voltage Vth2 (about 4.0 V, for example), the value of the input voltage Vin is larger than the set output voltage value Vset. In this case, by bringing the SBD 8 into conduction, a current path CP1 from the input terminal Tin to the output terminal Tout1 via the SBD 8 is formed. Namely, in the period T2a, the energy is discharged to the output terminal Tout1 by way of two paths of current supply paths CP1 and CP2. The value of the output voltage Vo1 is nearly the same as the value of the input voltage Vin.

Next, the operation in the period T3 of FIG. 5, which is the range where the input voltage Vin is equal to or higher than the threshold voltage Vth2 (about 4.0 V, for example), is explained.

In the period T3, the DC-DC converter 4 of FIG. 2 is operated in the operating mode 3. In this case, the comparator 12 of the comparison circuit 2 of FIG. 2 outputs the signal SS1 having a low level. Based on the low level of the signal SS1, the transistor Q6 of the voltage control oscillation unit 41 of the VCO 1 is in a conductive state. Therefore, the voltage control oscillator unit 41 is in a deactivated-state. In this case, the modulation clock signal CLKm is deactivated and maintained at low level. Further, based on the low level signal SS1, the switching controller 3 is also in a deactivated-state.

The high level signal SS2 is outputted from the comparator 43 of the VCO 1 of FIG. 3 to the switch unit 42. The switch unit 42 selects the node N12 based on the high level signal SS2. Accordingly, the modulation clock signal CLKm, which is maintained at a low level, is outputted as the control clock signal CLKO. Therefore, the PWM signal PS and the gate signal SQ2 are also maintained at a low level and the NMOS transistors Q2 and Q3 are deactivated. Further, since the gate signal SQ1 is maintained at a high level (as shown by the arrow A1 in FIG. 5) based on the inputting of the signal SS1 having a low level to the driver 23, the PMOS transistor Q1 is deactivated. Therefore, the switching controller 3 is deactivated. Then, the current supply path CP2 is interrupted.

Further, in the operating mode 3, the value of the input voltage Vin is larger than that of the output voltage Vo1. Therefore, the SBD 8 is brought into conduction and the current supply path CP1 is formed. Current is supplied from the input terminal Tin to the output terminal Tout1 only through the current supply path CP1 in the operating mode 3. At that time, the value of the output voltage Vo1 is determined by subtracting the voltage drop value VD (about 0.3 V, for example) at the SBD 8 from the input voltage Vin.

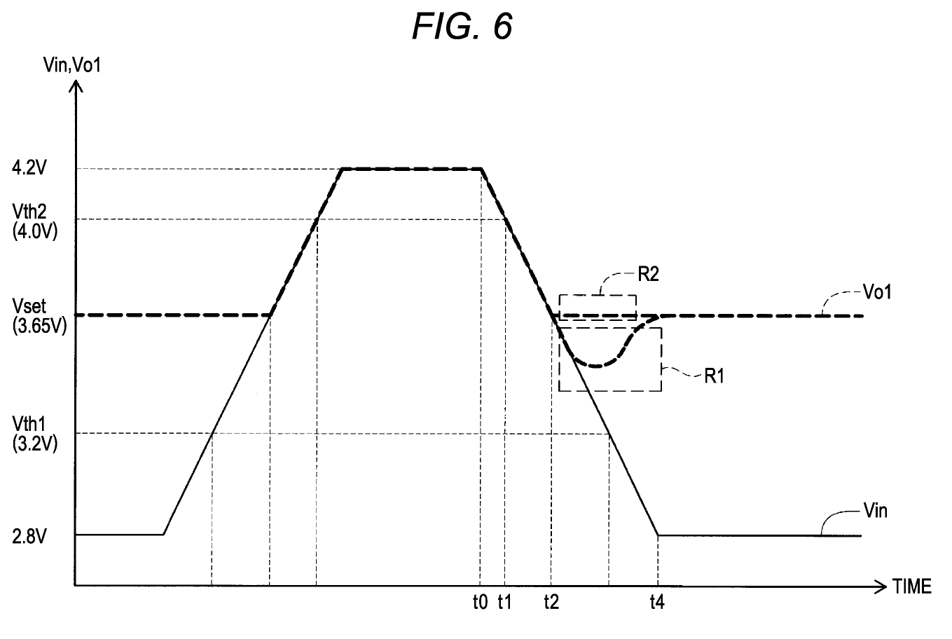

FIG. 6 depicts the relation between the input voltage Vin and the output voltage Vo1. Even when the input voltage Vin fluctuates within the range of about 2.8 V to about 4.2 V for example, the output voltage Vo1 is equal to or higher than the set output voltage value Vset (about 3.65 V, for example).

With the step-up DC-DC converter 4 of FIG. 2, when the input voltage Vin is higher than the set output voltage value Vset, the SBD 8 conducts and the current supply path CP1 is formed. Through the current supply path CP1, current is supplied from the input terminal Tin to the output terminal Tout1. In this case, the output voltage Vo1 is equal to or higher than the set output voltage value Vset while the step-up operation is not being performed at control circuit 11 of the DC-DC converter 4. In this case, if the switching controller 3 was operated at a constant frequency, wasteful circuit operation is performed and power loss may occur. However, with the DC-DC converter 4 of FIG. 2 described above, when the comparator 43 of the VCO 1 indicates the input voltage Vin is higher than the threshold value Vth1, the control clock signal CLKO with a decreased frequency is outputted from the clock signal generator 44. Namely, based on the comparison between the input voltage Vin and the threshold voltage Vth1, the operating frequency of the switching operation of the switching controller 3 is decreased. Accordingly, in the case that the input voltage Vin is higher than the set output voltage value Vset, power loss is decreased because redundant circuit operation is decreased.

Further, in a related step-up DC-DC converter, normally, on-duty of the PWM operation becomes small as the input voltage rises and becomes close to the set output voltage value. When the on-duty becomes as small as the minimum on-pulse time, the operation becomes unstable and problems such as generation of a ripple at output voltage may occur. However, with the DC-DC converter 4 of FIG. 2, by detecting that the input voltage Vin is higher than the threshold voltage Vth1, the input voltage Vin is raised and is close to the set output voltage value Vset. Based on the operation of the operating mode 2, the frequency of the control clock signal CLKO is decreased based on the increase of the input voltage Vin. When the frequency of the control clock signal CLKO is decreased, the on-pulse time becomes long. Therefore, the likelihood of PWM operation with a minimum on-pulse time is reduced and the DC-DC converter 4 of FIG. 2 operates stably.

The method of determining the value of the threshold voltage Vth1 is explained below. Within the range where the input voltage Vin is equal to or lower than the threshold voltage Vth1, the DC-DC converter 4 of FIG. 2 may need to be stably operated with the control clock signal CLKO at the frequency before the reduction (about 1.25 MHz, for example). Specifically, there exists a differential voltage between the input voltage Vin and the set output voltage value Vset which is may be needed for the stable operation of the DC-DC converter 4 of FIG. 2 with the control clock signal CLKO at about 1.25 MHz, for example. The value of the threshold voltage Vth1 is set to be equal to or smaller than the value calculated by subtracting the differential voltage from the set output voltage value Vset. The differential voltage for the stable operation of the DC-DC converter 4 of FIG. 2 is assumed to be about 0.4 V, for example. Therefore, the value of the threshold voltage Vth1 is set to about 3.2 V which is equal to or lower than the value of subtracting the differential voltage (about 0.4 V, for example) from the set output voltage value Vset (about 3.65 V, for example).

Further, with the DC-DC converter 4 of FIG. 2, in the case that comparison circuit 2 indicates the input voltage Vin is higher than the threshold voltage Vth2, the clock signal generator 44 deactivates the control clock signal CLKO and the circuit operation of the switching controller 3 is deactivated. Namely, the operation in the operation mode 3 is performed. Even when the switching controller 3 is deactivated, current is supplied from the input terminal Tin to the output terminal Tout1 through the current supply path CP1. Therefore, the output voltage Vo1 which has nearly the same voltage value as the input voltage Vin is outputted from the DC-DC converter 4 of FIG. 2. In this manner, the circuit operation of the switching controller 3 is deactivated based on the comparison between the input voltage Vin and the threshold voltage Vth2. Therefore, power loss is decreased because redundant circuit operation is decreased.

Next, the method of determining the value of the threshold voltage Vth2 is explained. The value of the output voltage Vo1 may need to be equal to or larger than that of the set output voltage value Vset. In the operating mode 3, the value of the output voltage Vo1 is calculated by subtracting the value of the voltage drop VD at the SBD 8 from the input voltage Vin. Therefore, the value of the threshold voltage Vth2 may need to be set equal to or larger than the value calculated by adding the voltage drop value VD to the set output voltage value Vset. The voltage drop value VD is assumed to be about 0.3 V, for example. Therefore, the value of the threshold voltage Vth2 is set to about 4.0 V which is equal to or larger than the value of adding 0.3 V to the set output voltage value Vset (about 3.65 V, for example).

Next, the operation of the DC-DC converter at rapid decreasing of the input voltage Vin is explained. The operation in the case that the input voltage Vin rapidly decreases from about 4.2 V to about 2.8 V, for example, in the period from time t0 through time t4 of FIG. 6 is explained below. First, the case that the switching controller 3 is deactivated and current is supplied to the output terminal Tout1 by utilizing the current supply path CP1 within the period from time t0 through time t2, which is the range where the input voltage Vin is higher than the set output voltage value Vset, is considered. In this case, the switching controller 3 is activated at time t2. However, since the step-up operation is not performed immediately after the activation, an overshoot may occur with the output voltage Vo1 as shown in range R1 of FIG. 6.

However, with the DC-DC converter 4 of FIG. 2, the switch controller 3 is activated at time t1 when the input voltage Vin becomes equal to or lower than the threshold voltage Vth2. Accordingly, the DC-DC converter 4 of FIG. 2 is already operating at time t2 and the step-up operation is performed. Therefore, overshoot of the output voltage Vo1 may be substantially reduced if not prevented as shown by the range R2. Namely, by activating the DC-DC converter 4 of FIG. 2 and by maintaining the DC-DC converter 4 in a stand-by state in the range where the input voltage Vin is higher than the set output voltage value Vset and lower than the threshold voltage Vth2, the speed of response to the rapid decrease of the input voltage may be improved.

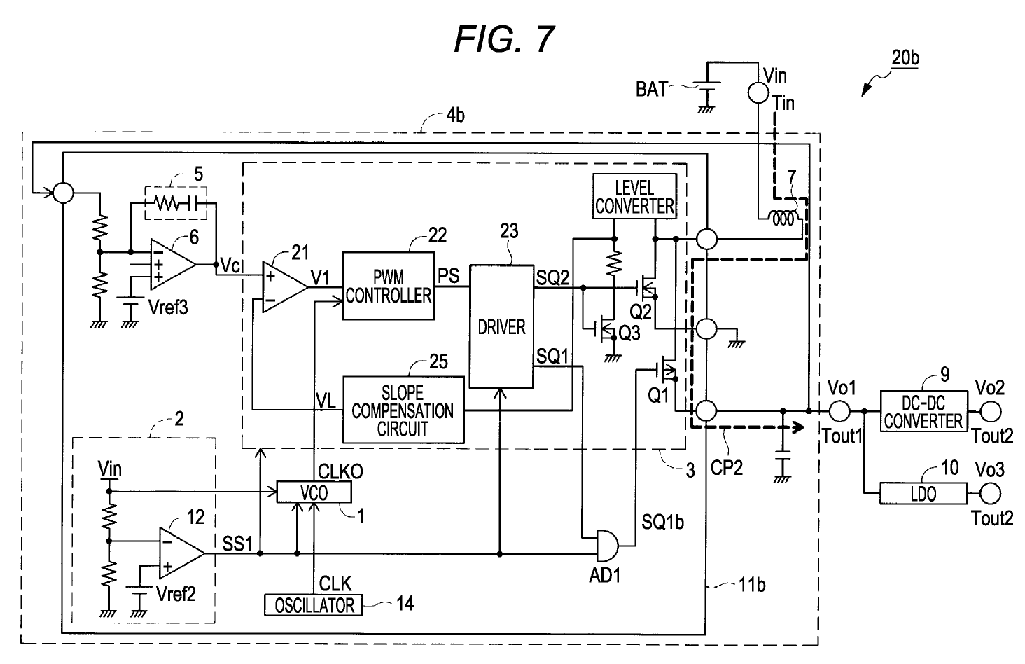

FIG. 7 depicts a double conversion type power apparatus 20b, which includes a DC-DC converter 4b. The DC-DC converter 4b, which is included in the power apparatus 20b, does not include the SBD 8 described above and depicted in the DC-DC converter 4 of FIG. 2. Here, the control circuit 11b includes an AND circuit AD1. The signal SS1 and the gate signal SQ1 are inputted to the AND circuit AD1 and the gate signal SQ1b is outputted to the transistor Q1. The gate signal SQ1b is inputted to the gate terminal of the transistor Q1. Here, since the rest of the structure is similar to the power apparatus 20 described above with respect to FIG. 2, detailed explanations of the similar components and operations are omitted.

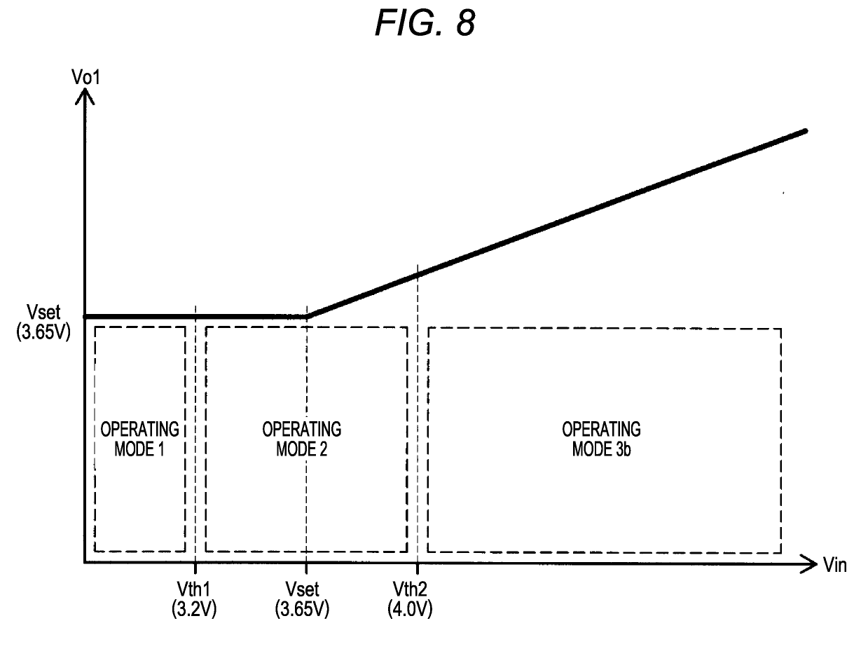

FIG. 8 depicts an example relation between input and output voltages of the power apparatus 20b depicted in FIG. 7. The operation of the power apparatus 20b of FIG. 7 is also explained with reference to FIG. 8. In the range where the input voltage Vin is lower than the threshold voltage Vth1, the DC-DC converter 4b of FIG. 7 performs the PWM operation at a substantially fixed frequency. The operation in this range is referred to as the operating mode 1.

As shown in FIG. 8, in the range where the input voltage Vin is equal to or higher than the threshold voltage Vth1 and lower than the threshold voltage Vth2, the DC-DC converter 4b of FIG. 7 performs the PWM operation at a frequency which decreases based on the input voltage Vin. The operation in this range is referred to as the operating mode 2.

As further shown in FIG. 8, in the range where the input voltage Vin is equal to or higher than the threshold voltage Vth2, the DC-DC converter 4b of FIG. 7 is deactivated and the transistor Q1 is in a conductive state. The operation in this range is referred to as the operating mode 3b.

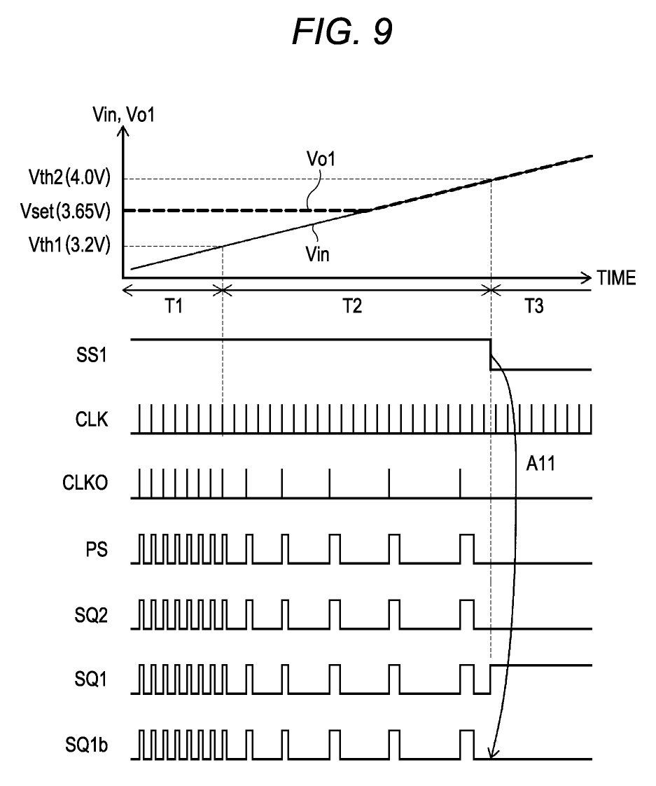

FIG. 9 depicts operating waveforms of the power apparatus 20b depicted in FIG. 7. The operation of the power apparatus 20b of FIG. 7 is also explained with reference to FIG. 9. The operation in the period T1, which is the range where the input voltage Vin is lower than the threshold voltage Vth1 (3.2 V), is explained below. In the period T1, the DC-DC converter 4b of FIG. 7 is operating in the operating mode 1. Therefore, the operation frequency of the transistor Q1 through Q3 is set to a substantially fixed frequency of about 1.25 MHz, for example. In the operating mode 1, the energy accumulated at the coil 7 is discharged to the output terminal Tout1 through the current supply path CP2.

As shown in FIG. 9, the operation in the period T2 in FIG. 9, which is the range where the input voltage Vin is equal to or higher than the threshold voltage Vth1 (about 3.2 V, for example) and lower than the threshold voltage Vth2 (about 4.0 V, for example), is explained. In the period T2, the DC-DC converter 4b of FIG. 7 is operating in the operating mode 2. The operating frequency of the transistors Q1 through Q3 is set within the range from about 980 kHz to about 420 kHz, for example. In the operating mode 2, as in the abovementioned operating mode 1, the energy accumulated at the coil 7 is discharged to the output terminal Tout1 through the current supply path CP2.

As further shown in FIG. 9, the operation in the period T3 in FIG. 9, which is the range where the input voltage Vin is equal to or higher than the threshold voltage Vth2 (about 4.0 V, for example), is explained. In the period T3, the DC-DC converter 4b of FIG. 7 is operating in the operating mode 3b. During the operating mode 3b, the comparator 12 of the comparison circuit 2 outputs the low level signal SS1. Based on the signal SS1 having a low level, the switching controller 3 is in a deactivated-state. Further, based on the signal SS1 having a low level, the VCO 1 is in a deactivated-state and the modulation clock signal CLKm is maintained at a low level. Therefore, the PWM signal PS and the gate signal SQ2 are also maintained at a low level and the NMOS transistors Q2 and Q3 are deactivated.

As further shown in FIG. 9, based on the input of the low level signal SS1, the driver 23 of FIG. 7 outputs the gate signal SQ1 having a high level. Based on the signal SS1 having a low level, the AND circuit AD1 masks the gate signal SQ1. Therefore, the gate signal SQ1b is maintained at low level (as shown by the arrow A11 in FIG. 9). Accordingly, since the PMOS transistor Q1 is fixed in a conductive state, the current supply path CP2 is formed. Therefore, in the operating mode 3b, current is supplied from the input terminal Tin to the output terminal Tout1 through the current supply path CP2.

As explained above, with the DC-DC converter 4b of FIG. 7, in the case that the operation is performed in the operating mode 3b during which the input voltage Vin is higher than the threshold voltage Vth2, the circuit operation of the switching controller 3 is deactivated. Further, by maintaining the PMOS transistor Q1 in the switching controller 3 in a conductive state, the current supply path CP2 is formed. Current is supplied from the input terminal Tin to the output terminal Tout1 through the current supply path CP2. Namely, the switching transistor Q1 for the DC-DC converter 4b is also utilized as a switch for forming the current supply path CP2. As a result, the SBD 8 for forming the current supply path CP1 which is included in the DC-DC converter 4 of FIG. 2 is not included in the DC-DC converter 4b depicted in FIG. 7. Accordingly, the number of components included in the DC-DC converter FIG. 4 may be less than the number of components included in the DC-DC converter 4b.

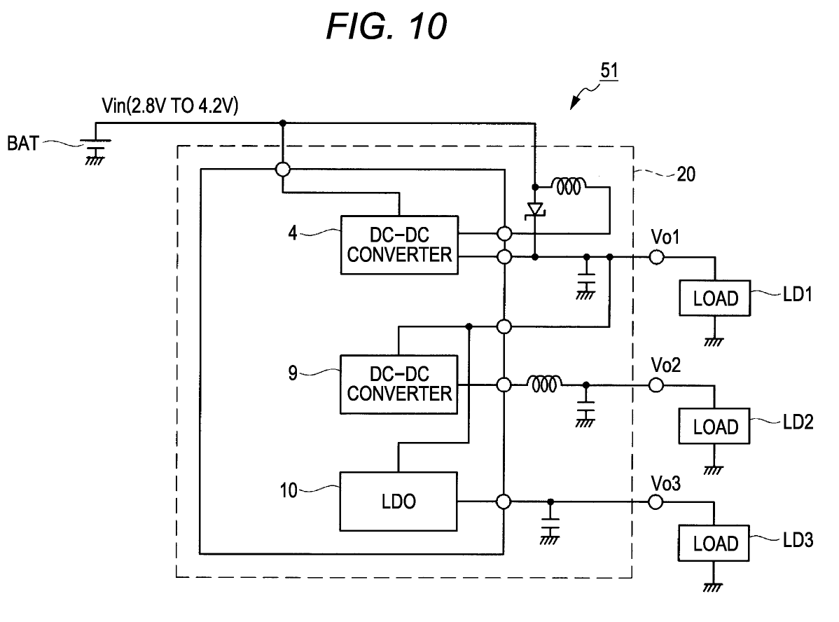

Electronics equipment may utilize and/or include the power apparatus 20 or the power apparatus 20b. For example, FIG. 10 depicts electronic equipment 51 utilizing the power apparatus 20. The electronic equipment 51 includes the battery BAT, the power apparatus 20 and loads LD1 through LD3. The input voltage Vin is inputted to the power apparatus 20. The power apparatus 20 supplies the output voltage Vo1. The output voltage Vo1 provided to the load LD1 may be equal to or larger than about 3.65 V, for example. IF the output voltage Vo1 may fluctuate around about 3.65 V, for example, the load LD1 may be a load (e.g., a LED etc.) which is unsusceptible to the fluctuation of the power voltage. Further, the power apparatus 20 may supply relatively constant output voltages Vo2 and Vo3 of about 3.3 V, for example, respectively to each of the loads LD2 and LD3.

The control circuit 11 of FIG. 2 and the control circuit 11b of FIG. 7 may be implemented as semiconductor chips, for example. The power apparatus 20 of FIG. 2 and the power apparatus 20b of FIG. 7 may also be implemented as semiconductor chips, for example. Further, the DC-DC converters 4 and 9 and the LDO 10 of FIG. 2 may be implemented as modules, for example.

Further, although the frequency of the control clock signal CLKO is changed linearly based on the input voltage Vin in the abovementioned disclosure, the change in frequency of the control clock signal is not limited to linear change. For example, the frequency could be changed in a stepwise manner.

Further, the circuit structure of the voltage control oscillation unit 41 of FIG.3 is not intended to be limited by FIG. 3. The voltage control oscillation unit 41 of FIG. 3 is an example of the circuit to change the frequency of the clock signal based on the value of the input voltage Vin. Therefore, another structure may be possible.

Here, the DC-DC converter 4 of FIG. 2 and the DC-DC converter 4b of FIG. 7 are explained as the case of a current mode. However, the current mode explanation is not intended to be limiting. The DC-DC converter 4 of FIG. 2 and the DC-DC converter 4b of FIG. 7 change the operating frequency based on the value of the input voltage Vin. However, a DC-DC converter of a voltage mode may be adopted.

In the abovementioned explanation, the power apparatus 20 has both the DC-DC converter 9 and the LDO 10. However, it may be possible that the power apparatus 20 is configured to have either the DC-DC converter 9 or the LDO 10.

Here, the transistor Q2 is an example of a first switch, the transistor Q1 is an example of a second switch, the threshold voltage Vth1 is an example of a first comparison voltage, the threshold voltage Vth2 is an example of a second comparison voltage, the comparator 43 is an example of a first comparator, the comparison circuit 2 is an example of a second comparator, the clock signal generator 44 and the oscillator 14 are examples of a signal generator, the clock signal CLKO is an example of a frequency signal, the switching controller 3 is an example of a first controller, the DC-DC converter 4 is an example of a power supply apparatus, and the signal SS2 is an example of a control signal.

A power supply apparatus according to an example of an embodiment of the present invention may include the first switch which is provided between an inductor and the terminal having a reference voltage, the second switch which is provided between the inductor and the output terminal, the first comparator which compares the input voltage and the first comparison voltage, the signal generator which outputs the frequency signal based on the output of the first comparator, and the first controller which controls current flowing into the inductor by controlling the first switch and the second switch based on the output of the signal generator.

A power supply method according to an example of an embodiment of the present invention may include comparing the input voltage and the first comparison voltage, outputting the frequency signal based on the comparison result of the input voltage and the first comparison voltage, and controlling current which flows into the inductor by controlling the first switch provided between the inductor and the terminal having the reference voltage and the second switch provided between the inductor and the output terminal based on the frequency signal.

According to an example of an embodiment of the present invention, current flows into the inductor due to the conduction of the first switch and energy is accumulated at the inductor. Further, the second switch is in a conductive state while the first switch is off and the energy accumulated at the inductor is discharged to the output terminal. The first comparator compares the input voltage and the first comparison voltage. The first comparison voltage preset as desired. The signal generator outputs the frequency signal based on the output of the first comparator. The first controller controls the first switch and the second switch at the operating frequency based on the frequency signal which is outputted from the signal generator. Accordingly, the output voltage which may be regulated at the set output voltage value.

A case in which the input voltage is higher than the set output voltage value when the power supply apparatus performs the step-up operation is considered. In this case, it may be possible to adopt a circuit structure which outputs the output voltage being equal to or higher than the set output voltage value without performing the step-up operation at the power supply apparatus. However, by operating the power supply apparatus at a constant frequency, redundant circuit operation may be performed, which may result in excess power loss. Accordingly, Power supply apparatuses such as those described with reference to FIGS. 2 and 7 are configured to output a frequency signal which frequency is decreased by the signal generator when the first comparator outputs a comparison result indicating the input voltage is higher than the first comparison voltage, for example. Namely, the operating frequency of the switching operation of the first controller is configured to decrease based on the comparison between the input voltage and the first comparison voltage. Accordingly, in a case in which the input voltage is higher than the set output voltage value, power loss may be less because redundant circuit operation is decreased in the power supply apparatuses of FIGS. 2 and 7 as compared with related power supply apparatuses.

A power supply apparatus according to an example of an embodiment of the present invention includes the first switch which is provided between the inductor and the terminal having the reference voltage, the second switch which is provided between the inductor and the output terminal, the second comparator which compares the input voltage and the second comparison voltage, the signal generator which outputs the frequency signal or is deactivated based on the output of the second comparator, the first controller which controls current flowing into the inductor by controlling the first switch and the second switch based on the output of the signal generator, and the current path which supplies current based on the input voltage to the output terminal in the case that the signal generator is deactivated.

Energy is accumulated at the inductor due to the conduction of the first switch. Then, the second switch is in a conductive state while the first switch is off and the energy accumulated at the inductor is discharged to the output terminal. The second comparator compares the input voltage and the second comparison voltage. The second comparison voltage may be previously set at desired. The signal generator outputs the frequency signal or is deactivated based on the output of the second comparator. The first controller controls the first switch and the second switch at the operating frequency based on the frequency signal which is outputted from the signal generator. Current corresponding to the input voltage is supplied to the output terminal through the current path when the signal generator is deactivated. Then, the output voltage which is equal to or higher than the set output voltage value is outputted from the power supply apparatus.

As mentioned above, in the case that the input voltage is higher than the set output voltage value when the power supply apparatus performs the step-up operation, redundant circuit operation may be performed in related power supply apparatuses. However, power supply apparatuses such as those described above with references to FIGS. 2 and 7 are configured to deactivate the circuit operation of the first controller by deactivating the frequency signal of the signal generator when the second comparator outputs a comparison result indicating the input voltage is higher than the second comparison voltage, for example. Even when the first controller is deactivated, the power supply apparatus outputs the output voltage which is equal to or higher than the set output voltage value because current corresponding to the input voltage is supplied to the output terminal through a current path. Namely, the circuit operation of the first controller is configured to be deactivated based on the comparison between the input voltage and the second comparison voltage. Accordingly, in the case that the input voltage is higher than the set output voltage value, power loss may be less in power supply apparatuses such as those described with reference to FIGS. 2 and 7 as compared to related power supply apparatuses because redundant circuit operation may be decreased.

The power supply apparatuses and the power supply methods described above provide low power consumption and stable operation.

Examples of embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made therein without departing from the spirit and scope of the present invention as set forth in the claims.

What is claimed is:

1. A power supply apparatus comprising:
an inductor;
a first switch provided between the inductor and a terminal having a reference voltage;
a second switch provided between the inductor and an output terminal;
a first comparator to compare a first input voltage and a second input voltage;
a signal generator to output a frequency signal based on an output of the first comparator; and
a first controller to control current flowing into the inductor by controlling the first switch and the second switch based on the output of the signal generator.

2. The power supply apparatus according to claim 1, further comprising:
a second comparator to compare the first input voltage and a third input voltage,
wherein the signal generator deactivates based on an output of the second comparator, and
wherein a current path for supplying current based on the first input voltage to the output terminal is formed when the signal generator is deactivated.

3. The power supply apparatus according to claim 2,
wherein the first comparator outputs a control signal for decreasing frequency of the frequency signal when the first input voltage becomes equal to or higher than the second input voltage.

4. The power supply apparatus according to claim 3,
wherein the signal generator decreases the frequency of the frequency signal as the value of the first input voltage increases if the first input voltage is higher than the second input voltage.

5. The power supply apparatus according to claim 1, wherein
the power supply apparatus has a differential voltage value between an output voltage value and the first input voltage, the differential voltage value being provided for stable operation of the power supply apparatus, and
the value of the second input voltage is equal to or smaller than a value obtained by subtracting the differential voltage value from the output voltage value.

6. The power supply apparatus according to claim 2,
wherein the value of the third input voltage is equal to or larger than a value obtained by adding a voltage drop value at the current path to the output voltage value of the power supply apparatus.

7. A power supply apparatus comprising:
a first switch provided between an inductor and a terminal having a reference voltage;
a second switch provided between the inductor and an output terminal;
a second comparator comparing an input voltage and a second comparison voltage;
a signal generator outputting a frequency signal or is deactivated based on output of the second comparator;
a first controller controlling current flowing into the inductor by controlling the first switch and the second switch based on the output of the signal generator; and
a current path supplying current based on the input voltage to the output terminal in the case that the signal generator is deactivated.

8. The power supply apparatus according to claim 2, further comprising:
a second controller inputted output of the first controller and output of the second comparator,
wherein the second controller turns on the second switch in case that the signal generator is deactivated, and couples the inductor and the output terminal as a path which is defined as the current path.

9. The power supply apparatus according to claim 2, further comprising:
a diode which is coupled between the inductor and the output terminal.

10. The power supply apparatus according to claim 9,
wherein a path which couples the diode and the output terminal is the current path in the case that the signal generator is deactivated.

11. The power supply apparatus according to claim 7,
wherein the second comparator outputs a control signal to deactivate the frequency signal in the case that the input voltage is equal to or higher than the second comparison voltage.

12. The power supply apparatus according to claim 7,
wherein the value of the second comparison voltage is equal to or larger than the value of adding a voltage drop value at the current path to the set output voltage value of the power supply apparatus.

13. A power supply method comprising:
comparing a first input voltage and a second input voltage;
outputting a frequency signal based on the comparison result; and
controlling current flowing into an inductor by controlling a first switch provided between the inductor and a terminal having a reference voltage and a second switch provided between the inductor and an output terminal based on the frequency signal.

14. The power supply method according to claim 13, further comprising:
comparing the first input voltage and a third input voltage;
and s deactivated based on the comparison result between the input voltage and the second comparison voltage, and
wherein a current path for supplying current based on the input voltage to the output terminal is formed in the case that the frequency signal is deactivated.

15. The power supply method according to claim 13, further comprising:
decreasing a frequency of the frequency signal when the input voltage becomes equal to or higher than the second input voltage.

16. A power supply apparatus comprising:
a first switch provided between an inductor and a terminal having a reference voltage;
a second switch provided between the inductor and an output terminal;
a first control loop to control the first switch and the second switch while monitoring an output voltage; and
a second control loop to control the first switch and the second switch while monitoring an input voltage.

17. The power supply apparatus according to claim 16,
wherein the second control loop decreases control frequency of the first switch and the second switch or deactivates control of the first switch and the second switch based on an increase in the input voltage.
